(19) United States
(12) Patent Application Publication
(10) Pub. No.: US 2015/0114906 A1
(43) Pub. Date: Apr. 30, 2015

(54) SILYLATED MESOPOROUS SILICA MEMBRANES ON POLYMERIC HOLLOW FIBER SUPPORTS

(71) Applicants: Phillips 66 Company, Houston, TX (US); Georgia Tech Research Corporation, Atlanta, GA (US)

(72) Inventors: Sankar Nair, Atlanta, GA (US); Hyung-Ju Kim, Atlanta, GA (US); William J. Koros, Atlanta, GA (US); Kwang-Suk Jang, Atlanta, GA (US); Justin R. Johnson, Atlanta, GA (US); Christopher W. Jones, Atlanta, GA (US); Joe D. Allison, Bartlesville, OK (US); Jeffrey H. Drese, Bartlesville, OK (US)

(73) Assignees: Phillips 66 Company, Houston, TX (US); Georgia Tech Research Corporation, Atlanta, GA (US)

(21) Appl. No.: 14/515,613

(22) Filed: Oct. 16, 2014

Related U.S. Application Data
(60) Provisional application No. 61/895,145, filed on Oct. 24, 2013.

(51) Int. Cl. B01D 71/02; B01D 69/02; C02F 1/44; B01D 67/00; B01D 69/08

(52) U.S. Cl. CPC B01D 71/027; B01D 67/0069; B01D 67/0095; B01D 67/0093; B01D 69/08; C02F 1/448; B01D 69/02; B01D 2323/14; C02F 2101/34
USPC 210/640; 210/500.23; 427/244

(57) ABSTRACT

Described is a liquid separation device comprising a porous support structure further comprising polymeric hollow fibers; an inorganic mesoporous silica membrane disposed on the porous support structure, wherein the inorganic mesoporous silica membrane is free of defects; and wherein the inorganic mesoporous silica membrane has a network of interconnected three-dimensional pores that interconnect with the porous support structure; and wherein the inorganic mesoporous silica membrane is a silylated mesoporous membrane. Also described are methods for making and using the liquid separation device.

### CROSS-REFERENCE TO RELATED APPLICATIONS

The present application claims priority to U.S. Provisional Patent Application No. 61/895,145, filed on Oct. 24, 2013, for “Silylated Mesoporous Silica Membranes on Polymeric Hollow Fiber Supports.”

### TECHNICAL FIELD

This invention relates generally to membranes for fluid molecular separation, and more particularly to silylated mesoporous silica on polymeric hollow fiber membranes.

### BACKGROUND OF THE INVENTION

Separation membranes have various potential industrial applications including organic/water separations in the production of biofuels, bio-based chemicals, pharmaceuticals and biomolecules. Membrane-based gas separations have a growing market share due to low energy requirements and facile scale-up of the separation unit. Currently, fluid separation applications may involve the use of porous polymeric or inorganic membranes. Polymeric membranes used for fluid separation applications may be fabricated in a hollow fiber form. Hollow fiber modules have a high surface area/volume ratio, typically in the range of 5,000-10,000 m²/m³, which is an important design consideration for commercial large-scale processes. While polymeric hollow fibers may be adequate for some separation processes, the fluid separation performance of polymeric materials may be limited by their chemical composition and structure.

Despite concentrated efforts to tailor polymer structure to improve separation properties, current polymeric membrane materials have seemingly reached a limit in the trade-off between productivity and selectivity. Although this trade-off is well-studied in the context of gas separations, it also exists in liquid organic/water separations.

Therefore, it remains highly desirable to provide an alternate cost-effective membrane with improved separation properties compared to the polymer membranes. In particular, a long-standing goal has been to produce a selective inorganic membrane on a highly scalable and economical platform (such as a polymeric hollow fiber).

To make such separation membranes more competitive with other separation processes, such as distillation, adsorption and cryogenic separations, there is a need to develop mesoporous silica membranes grown on polymeric hollow fibers with at least one of the following properties:
a) separation selectivity comparable or superior to polymeric membranes, and higher throughput than polymeric membranes;
b) high membrane surface area/volume (e.g., hollow fiber membrane module); and
c) facile scale-up for commercial separation processes.

Thus, a fabrication method is also needed for such mesoporous silica membranes, and their subsequent silylation for use in organic/water separations.

### SUMMARY OF THE INVENTION

This invention relates generally to membranes for liquid molecular separation and, more particularly, to silylated mesoporous silica on polymeric hollow fiber membranes. Silylated mesoporous silica membranes grown on polymeric hollow fiber supports have been fabricated for the first time, thereby suggesting a scalable membrane platform for organic recovery applications. The silylated mesoporous membranes were selective for permeation of organic molecules in ethanol (EtOH)/water, methyl ethyl ketone (MEK)/water, ethyl acetate (EA)/water, isobutanol (i-BuOH)/water, and n-butanol (n-BuOH)/water pervaporation experiments, whereas the bare membranes are selective for water.

We have surprisingly been able to develop a processing route for making thin, defect-free, silylated mesoporous silica membranes on polymeric hollow fibers, and furthermore used them as a selective membrane for organic/water separation. Additionally, the silylated mesoporous coated hollow fibers of the invention can be packed together (in the thousands to millions) to make highly compact membrane modules with membrane surface areas of several thousand square meters per cubic meter of module volume.

The method of the invention allows the cost effective synthesis of silylated mesoporous membranes on porous polymeric hollow fibers for use in various organic/water separation technologies.

Generally speaking, the method comprises four steps. First, immersion of porous polymeric hollow fibers in an acidic precursor solution containing dissolved silica and a long-chain quaternary amine surfactant (quat). Second, a vapor-phase treatment is performed with a silica source to complete the formation of a stable mesoporous coating. Third, the quaternary amine is extracted from the mesopores by treatment with an appropriate solvent, thereby opening the mesopores for permeation. Finally, after quat extraction, the mesopores are open for treatment with an appropriate silylation agent (e.g., hexamethyldisilazane (HMDS), heptamethyldisilazane) to impart molecular selectivity to the membrane for organic molecules. In contrast, the bare membranes are selective for water. The porous polymeric hollow fibers can be previously produced by an established spinning process.

In more detail, the method includes preparing a coating solution, wherein the coating solution comprises a mixture of a silica source, a quaternary amine surfactant, and acidic water; immersing polymeric hollow fibers in the coating solution, thereby forming a wet mesoporous silica membrane on the polymeric hollow fibers; rinsing and drying the wet mesoporous silica membrane on the polymeric hollow fibers, thereby forming a dried mesoporous silica membrane on the polymeric hollow fiber; and aging the dried mesoporous silica membrane in a vapor of, for example, saturated alkoxysilane. If desired, the quaternary amine molecules can be extracted from the membrane by treatment with an appropriate solvent, rinsing and drying. The remaining mesoporous hollow fiber can then be silylated as desired for a particular application.

The support polymeric hollow fiber used can be any suitable polymer or copolymer made by any conventional method, e.g., spun from a solution through a spinneret. Such hollow fibers include polymeric hollow fibers including various types of polyamide-imides (e.g. TORLON®), polyetherimides (e.g., ULTEM® 1000), polyimides (e.g., MATRIMID®), PVP, CA, PSF, PAN, EC, AR and the like.

The silica in the dissolved silica (silicon hydroxide, also referred to as silicic acid or [SiOₓ(OH)₄₋₂ₓ]ₙ) can be from any source. Silicic acids may be formed by acidification of silicate salts (such as sodium silicate) in aqueous solution, and herein we employed a common source of silica, which is tetraethylorthosilicate (TEOS). It is known that use of different alkoxysilanes can control the type of mesoporous silica. The use of TEOS can create a mesoporous silica Mobil Composition Matter 48 (MCM-48) surface, whereas the use of other silicates and surfactants can create other mesoporous silicas.

Quaternary amine surfactants (also known as quats) include the positively charged polyatomic ions of the structure NR₄⁺, R being an alkyl or aryl group, and where each R can be the same or different. In preferred embodiments, the R is an alkyl or aryl of at least 6, for example 8 carbons. Preferred quaternary amine surfactants include benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride and domiphen bromide, and the like. Particularly preferred is cetyltrimethylammonium bromide (CTAB).

One embodiment of a liquid separation device in accordance with the present disclosure includes a porous support structure comprising polymeric hollow fibers and a mesoporous membrane or coating disposed on the porous support structure, wherein the mesoporous membrane comprises an inorganic material such as silica. Moreover, the pore diameter of these materials can be controlled within mesoporous range between about 1.5 nm to about 20 nm by adjusting the synthesis conditions and/or by employing surfactants with different chain lengths in their preparation.

It is possible to scale up the preparation of one foot or longer silica/CTAB membranes in the present disclosure free of any substantial defect, and such long coated hollow fibers can be bundled together to make various separation devices. There appears no limitation to the formation of these coatings on hollow fibers of any desirable length. These devices can then be used in various separation or purification processes.

These and other objects, features, and advantages will become apparent as reference is made to the following detailed description, preferred embodiments, and examples, given for the purpose of disclosure, and taken in conjunction with the accompanying drawings and appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a further understanding of the nature and objects of the present invention, reference should be made to the following detailed disclosure, taken in conjunction with the accompanying drawings, in which like parts are given like reference numerals, and wherein:

FIG. 1A illustrates a top view scanning electron microscope (SEM) image of an evacuated mesoporous silica on polyamide-imide hollow fiber membranes;

FIG. 1B illustrates a cross-sectional view SEM image of an evacuated mesoporous silica on polyamide-imide hollow fiber membranes;

FIG. 1C illustrates a top view SEM image of a hexamethyldisilazane (HMDS)-silylated mesoporous silica on polyamide-imide hollow fiber membranes according to an embodiment of the present invention;

FIG. 1D illustrates a cross-sectional SEM image of a HMDS-silylated mesoporous silica on polyamide-imide hollow fiber membranes according to an embodiment of the present invention;

FIG. 2A illustrates a chart of Feed Pressure (psig) vs. Permeance (GPU), showing single N₂ and CO₂ gas permeation results for template-extracted mesoporous silica on polyamide-imide hollow fiber membranes;

FIG. 2B illustrates a chart of Feed Pressure (psig) vs. Permeance (GPU), showing single N₂ and CO₂ gas permeation results for evacuated mesoporous silica on polyamide-imide hollow fiber membranes;

FIG. 2C illustrates a chart of Feed Pressure (psig) vs. Permeance (GPU), showing single N₂ and CO₂ gas permeation results for silylated mesoporous silica on polyamide-imide hollow fiber membranes according to an embodiment of the present invention;

FIG. 3A illustrates a chart of Feed Pressure (psig) vs. Permeance (GPU), showing single N2 and CO2 gas permeation results for silica-free polyamide-imide hollow fiber;

FIG. 3B illustrates a chart of Feed Pressure (psig) vs. Permeance (GPU), showing single N2 and CO2 gas permeation results for silylated polyamide-imide hollow fiber;

FIG. 4A illustrates a line scanning analysis of energy-dispersive X-ray spectroscopy (EDS) of the silylated polyamide-imide hollow fiber membrane according to an embodiment of the present invention;

FIG. 4B illustrates an anticipated chemical reaction for polyamide-imide hollow fiber and HMDS;

FIG. 5 illustrates a chart of 2 Theta (A) vs. Intensity, showing X-ray diffraction (XRD) patterns of (a) template-extracted, (b) evacuated, and (c) silylated mesoporous membranes;

FIG. 6A illustrates a high-resolution transmission electron microscopy (TEM) image of a template-extracted mesoporous membrane layer after dissolution of the polyamide-imide hollow fiber;

FIG. 6B illustrates a TEM image of an evacuated mesoporous membrane layer after dissolution of the polyamide-imide hollow fiber;

FIG. 6C illustrates a TEM image of a silylated mesoporous membrane layer after dissolution of the polyamide-imide hollow fiber;

FIG. 7 illustrates a TEM analysis (height, width) of a template-extracted mesoporous silica on polyamide-imide hollow fiber membrane;

FIG. 8 illustrates a TEM analysis (height, width) of an evacuated mesoporous silica on polyamide-imide hollow fiber membrane;

FIG. 9 illustrates a TEM analysis (height, width) of a silylated mesoporous silica on polyamide-imide hollow fiber membrane according to an embodiment of the present invention;

FIG. 10 illustrates a chart of Wavenumber (cm-1) vs. Absorbance (a.u.), showing an attenuated total reflectance (FT-ATR) absorption spectra of mesoporous silica on polyamide-imide hollow fiber membranes using a background spectrum from a polystyrene (PS) plate;

FIG. 11A illustrates a chart of various 5% by weight organic/water feed mixtures vs. Flux (kg/m²h) and Separation factor (β), showing pervaporation data (flux and organic/water separation factor) at 303° K and 323° K for an evacuated mesoporous membrane before silylation;

FIG. 11B illustrates a chart of various 5% by weight organic/water feed mixtures vs. Flux (kg/m²h) and Separation factor (β), showing pervaporation data (flux and organic/water separation factor) at 303° K and 323° K for a silylated mesoporous membrane according to an embodiment of the present invention;

FIG. 11C illustrates a chart of various 5% by weight organic/water feed mixtures vs. Permeance (GPU) and Selectivity (α), showing pervaporation data (permeance and organic/water selectivity) at 303° K and 323° K for an evacuated mesoporous membrane before silylation;

FIG. 11D illustrates a chart of various 5% by weight organic/water feed mixtures vs. Permeance (GPU) and Selectivity (α), showing pervaporation data (permeance and organic/water selectivity) at 303° K and 323° K for silylated mesoporous membrane according to an embodiment of the present invention;

FIG. 12A illustrates a chart of various 5% by weight organic/water feed mixtures vs. Permeability (Barrer) and Selectivity (α), showing pervaporation data (permeability and organic/water selectivity) at 303° K and 323° K for an evacuated mesoporous membrane before silylation;

FIG. 12B illustrates a chart of various 5% by weight organic/water feed mixtures vs. Permeability (Barrer) and Selectivity (α), showing pervaporation data (permeability and organic/water selectivity) at 303° K and 323° K for a silylated mesoporous membrane;

FIG. 13A illustrates a chart of various 5% by weight organic/water feed mixtures vs. Flux (kg/m²h) and Separation Factor (β), showing pervaporation data (flux and organic/water separation factor) at 303° K and 323° K for an extracted mesoporous membrane;

FIG. 13B illustrates a chart of various 5% by weight organic/water feed mixtures vs. Permeance (GPU) and Selectivity (α), showing pervaporation data (permeance and organic/water selectivity) at 303° K and 323° K for an extracted mesoporous membrane;

FIG. 13C illustrates a chart of various 5% by weight organic/water feed mixtures vs. Permeability (Barrer) and Selectivity (α), showing pervaporation data (permeability and organic/water selectivity) at 303° K and 323° K for an extracted mesoporous membrane;

FIG. 14 illustrates Table 1, showing data for concentration upgrade from feed to permeate at 303° K for a silylated mesoporous silica on polyamide hollow fiber membrane according to an embodiment of the present invention; and

FIG. 15 illustrates Table 2, showing data for concentration upgrade from feed to permeate at 303° K for a template-extracted mesoporous silica on polyamide-imide hollow fiber membrane.

### DETAILED DESCRIPTION OF PREFERRED EMBODIMENTS OF THE INVENTION

The following detailed description of various embodiments of the present invention references the accompanying drawings, which illustrate specific embodiments in which the invention can be practiced. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains. Therefore, the scope of the present invention is defined only by the appended claims, along with the full scope of equivalents to which such claims are entitled.

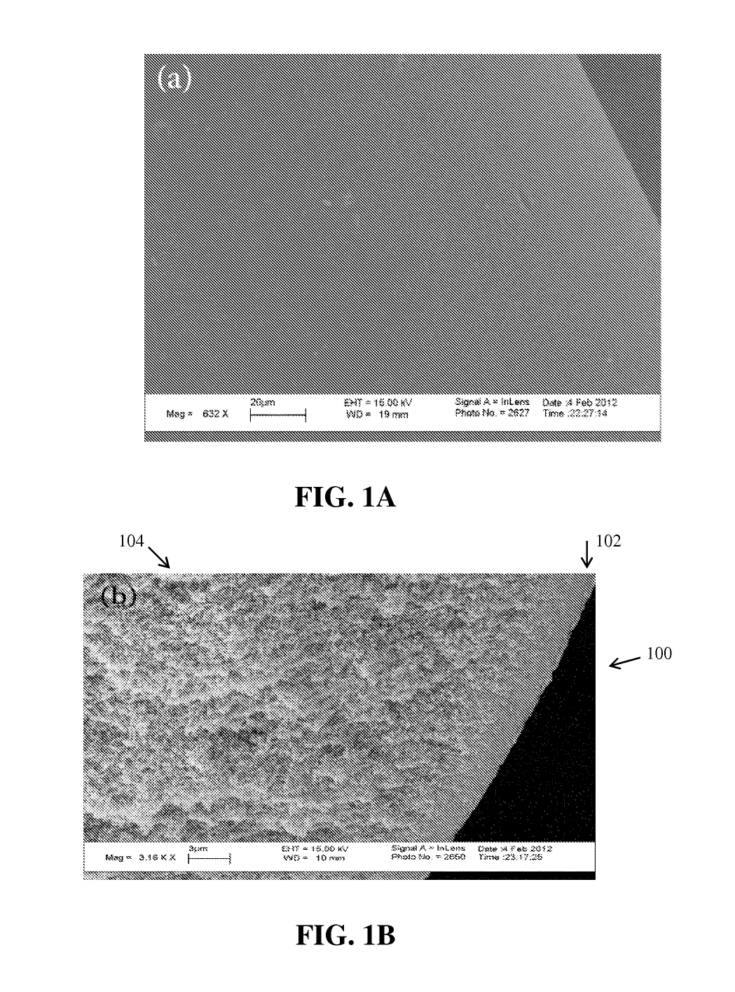

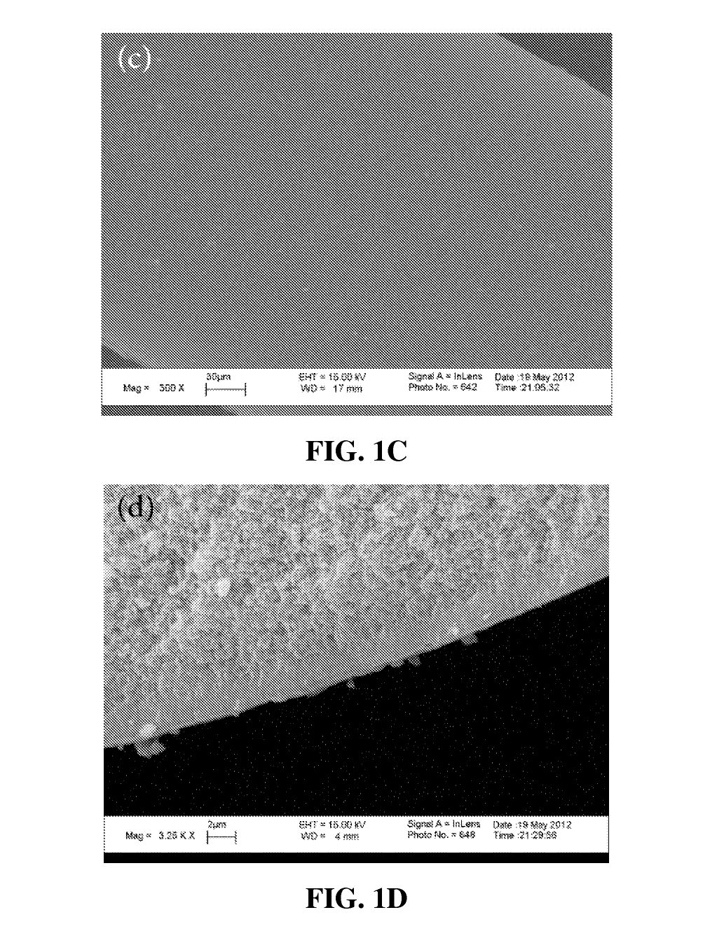

One aspect of the present invention relates to liquid separation devices and methods of making and using such devices. Referring to FIG. 1, which is a cross-section image of a liquid separation device 100, a mesoporous membrane 102 is disposed on a porous support structure 104 comprising polymeric hollow fibers. The mesoporous membrane 102 has a mesoporous structure that includes a network of three-dimensional pores that connect with the pores of the hollow fiber. The pores of the membrane 102 may be between about 0.1 to about 10 nm in diameter, preferably about 1 to about 4 nm, about 2 to about 4 nm, or about 3 nm in diameter.

The mesoporous membrane 102 may comprise a suitable inorganic material, such as mesoporous MCM. The MCM may be silica-based, such as MCM-48 or MCM-41, and the like.

The mesoporous membrane 102 may comprise a suitable inorganic material, such as a mesoporous silica. For example, the composite inorganic material may include a mesoporous silica-type material and a quaternary amine. In an exemplary embodiment, the mesoporous membrane 102 may comprise mesoporous silica and cetyltrimethylammonium bromide (CTAB). The CTAB may be disposed in the network of pores formed in the mesoporous structure.

The porous support structure 104 may be made from any suitable polymer spun by a conventional method (e.g., spun from a solution through a spinneret). Macroporous hollow fiber supports may be fabricated by a dry-jet/wet-quench method. (See e.g., Brown, A. J., et al., ANGEW CHEM. INT′L EDIT. 51 (2012) 10615-10618). Exemplary hollow fiber polymers include polyamide-imides (e.g. TORLON®), polyetherimides (e.g., ULTEM® 1000), polyimides (e.g., MATRIMID®), PVP, CA, PSF, PAN, EC, AR, and the like.

An exemplary self-assembly method is provided herein for preparing a mesoporous silica/CTAB composite membrane. Conventional techniques for coating silica/surfactant composite films with 2-dimensional hexagonal, 3-dimensional hexagonal and simple cubic structures on dense flat surfaces are described in Aksay, I. A., et al., SCIENCE, 273 (1996) 892-898; Yang, H., et al., J. MATER. CHEM., 7 (1997) 1285-1290; Miyata, H., et al., NAT. MATER., 3 (2004) 651-656, all of which are hereby incorporated by reference.

The present disclosure, however, provides an improved immersion technique for disposing a composite membrane on porous hollow fibers as well as on a flat, dense surface. The presence of the porous, rough surface alters the mechanism of formation of the mesoporous coating in comparison to a flat, dense surface, because the combination of physical and chemical interactions between the reactants and the surface changes. Importantly, the mesoporous coatings must be uniform over large areas and/or fiber lengths, and free of defects (such as pin-holes and cracks) over large areas and/or fiber lengths. Therefore, molecules should only permeate through the pores of the mesoporous material.

In an embodiment according to the present disclosure, a mesoporous silica/CTAB composite membrane layer is prepared by immersion of the polymeric hollow fibers in a coating solution containing a dissolved silica source, CTAB, and acidic water for between about 10 minutes and about 24 hours at a temperature of between about 10° C. to 80° C. The pH of the coating solution may be between about 0 and about 4, as adjusted by adding an acid (e.g., HCl). The composition of the mixture solution may be expressed in terms of the following molar ratios: 1.0 SiO₂:a CTAB:b H₂O. In an embodiment, a is between about 0.1 and about 1, and b is between about 20 and about 200. In one embodiment, the source of silica is alkoxysilane, such as TEOS, fumed silica, colloidal silica and the like.

After immersion of at least a portion of the polymeric hollow fibers in the coating solution, a mesoporous silica/CTAB composite membrane layer is grown on the surface of the polymeric hollow fibers. It is believed that during substrate immersion in the coating solution, surfactants are adsorbed on the surface of the substrate and self-assemble to form ordered micelles. At the same time, capillary forces can be used to drive the reactant solution into the pores of the hollow fiber near the surface, thereby further assisting the formation of a continuous membrane. Silica precursors are intercalated into the self-assembled surfactants, and, thereby, the mesoporous silica/CTAB composite is grown at the surface of the porous substrate.

The resultant mesoporous silica/CTAB membranes include a silica structure containing a network of 3-dimensionally ordered pores filled with CTAB molecules. The diameter of the channels is preferably between about 1 nm and about 5 nm. In the mesoporous silica/CTAB membrane, CTAB molecules may be confined within the rigid silica wall, and continuously connected to each other.

The presence of a mesoporous silica/CTAB membrane or coating is confirmed by scanning electron microscopy (SEM) as shown in FIG. 1B. The mesoporous silica/CTAB membrane is shown to be disposed on a transition layer of the coated polymeric hollow fibers.

The thickness of the mesoporous silica/CTAB membrane layer depends in part on the immersion time and the porous structure of the polymeric hollow fibers. The layer thicknesses can be measured by scanning electron microscopy (SEM). As shown in FIG. 1B, the membrane layer thickness is about 1.6 μm.

The mesoporous silica/CTAB membrane is then aged with saturated TEOS vapor in a closed vessel prior to use. We have discovered that the initial coating of mesoporous silica is silicon-deficient (i.e., there are not enough silicate species to form a mechanically strong network, even though it does form a cubic pore structure). However, when exposed to TEOS vapor, additional silica species were provided and incorporated into the existing network, thus strengthening the mesoporous structure. In one embodiment, an aging temperature is between about 50° C. and about 150° C., and an aging period is between about 1 hour and about 48 hours.

The gas separation performance of hollow fiber membranes can be evaluated by measuring its gas permeance. Permeance is measured in gas permeation units (GPU), which is defined as follows:

GPU=(10⁻⁶×cm³(STP))/(cm²×sec×(cm Hg)

In other words, permeance of a membrane may be measured in terms of the amount of gas permeated by the membrane per unit time (cm³(STP)/sec) per unit (cm²) surface area of the membrane, per unit pressure difference (cm Hg) across the membrane. The selectivity of gas separation membranes is defined as the ratio of the rate of passage of the more permeable components (e.g., CO₂) to the rate of passage of the less permeable component (e.g., N₂).

In an embodiment, the support polyamide-imide (e.g., TORLON®) hollow fiber has CO₂ permeance of 50,000 GPU and CO₂/N₂ selectivity of 0.93 at 35° C. for gases with 10 psig feed pressure. In another embodiment, N₂ and CO₂ permeances of the mesoporous silica/CTAB membrane coated on polyamide-imide (e.g., TORLON®) hollow fibers were measured at the 50 psig feed pressure. The silica/quat membrane has CO₂ permeance of 11 and CO₂/N₂ selectivity of 1.9. Selective transport of CO₂ through silica/quat composite membranes is facilitated by adsorption of CO₂ to quaternary amine group of CTAB and by diffusion through continuously connected CTAB channels.

In another embodiment, the quaternary amine molecules confined within the ordered silica wall can be removed by the solvent extraction. The extraction method used in the present disclosure allows the production of mesoporous silica membranes with continuous open pore channels formed on support polymeric hollow fibers. In this embodiment, the quaternary amine molecules are extracted using a solvent such as water, alcohols or a mixture thereof, for a period between about 1 hour and about 72 hours at a temperature between about 20° C. and about 100° C. The pH of the extraction solvent may be between about 0 to about 7, as adjusted by adding an acid (e.g., HCl). Examples of alcohols include, but are not limited to, methanol (MeOH), ethanol (EtOH), propanol (PrOH), isopranol (i-PrOH), n-butanol (n-BuOH), isobutnaol (i-BuOH), sec-butanol (sec-BuOH), and tert-butnaol (tert-BuOH).

After the solvent extraction, the mesoporous silica membrane coated on polyamide-imide (e.g., TORLON®) hollow fiber has a CO₂ permeance of 4,400 GPU and N₂ permeance of 3,300 GPU at 35° C. for gases with 50 psig feed pressure. The support polyamide-imide (e.g., TORLON®) hollow fiber has a CO₂ permeance of 50,000 GPU and N₂ permeance of 54,000 GPU at 35° C. for gases with 10 psig feed pressure. These permeances show that CTAB has been extracted and the mesoporous silica membrane has continuous open pore channels.

After quat extraction, the mesoporous channels are open for treatment with an appropriate silylation agent (e.g., hexamethyldisilazane (HMDS), heptamethyldisilazane) in order to impart molecular selectivity to the membrane for organic molecules. In contrast, the bare membranes are selective for water. With the selective use of silylation agents, the separation devices can be used in organic/water separation applications.

These embodiments provide an organic selective membrane with a hollow fiber support and its economically feasible manufacture method. The silylated mesoporous silica membranes of the present invention can be prepared by simile immersion, vapor deposition, extraction and silylation techniques.

### Example

### Mesoporous Silica Membrane Coating on Polyamide-Imide Hollow Fibers

### Synthesis of Mesoporous Silica Membrane

As a support polymeric fiber, polyamide-imide (e.g., TORLON®) hollow fibers were used. Macroporous polyamide-imide (e.g., TORLON®) hollow fiber supports were fabricated by a dry-jet/wet-quench method. (See e.g., Brown, A. J., et al., ANGEW CHEM. INT′L EDIT. 51 (2012) 10615-10618). The polyamide-imide (e.g., TORLON®) hollow fibers were spun from a solution through a spinneret. The inner diameter of the support fiber was ca. 230 μm, and the outer diameter of the support fiber was ca. 380 p.m. The fiber layer thickness was in the range of about 30 to about 100 μm, and, preferably in the range of about 30 to about 60 p.m. The support fiber layer was composed of substructure and transition layers but not skin layers. The thickness of the transition layer was about 8 lam and the pore size of transition layer was about 100 nm at the outer surface.

The mesoporous silica membrane was fabricated by simple immersion, vapor deposition and extraction techniques. (See Jang, K. S., et al., CHEM. MATER, 23 (2011) 3025-3028). Before the membrane coating, both ends of the fiber support were sealed with epoxy to prevent the membrane growth in the interior of the fiber support. The support polyamide-imide (e.g., TORLON®) hollow fibers were immersed in the coating solution for about 5 hours at room temperature. The mixture had the approximate molar composition of 1 TEOS: 0.425 CTAB: 0.00560 HCI: 62.2 H₂O.

After the immersion process, the prepared hollow fiber membranes were aged with saturated TEOS vapor prior to use. A 22 cm-long fiber membrane was placed with 25 μL of TEOS in a closed vessel at 373° K for 24 hours. After the aging process, the fiber membranes were washed with 0.05 N HCl/ethanol under stirring for about 24 hours to extract the surfactant.

### Evacuation and Silylation of Mesoporous Silica Membrane

After the extraction process, the extracted mesoporous silica membranes were evacuated in a vacuum oven at 423° K under 0.07 atm, to remove physically adsorbed moisture and residual surfactant prior to silylation.

After the evacuation process, the evacuated membranes were exposed to HMDS vapor in a closed vessel at 373° K for about 24 hours. After the silylation process, the silylated membranes were washed with deionized water for about 30 minutes in a separate container under stirring. After the water extraction process, the coated membranes were dried at 363° K before preparing the pervaporation measurement module.

### Characterization of the Mesoporous Silica Membranes

FIGS. 1A-1B show scanning electron microscopy (SEM) images of the mesoporous silica on polyamide-imide (e.g., TORLON®) hollow fiber membranes after evacuation. SEM was performed with a LEO 1530 instrument to examine the membranes. The membrane samples were prepared on carbon tape and coated with gold to prevent image distortion due to surface charging. As depicted in FIGS. 1A-1B, continuous and uniform silica layers may be obtained in a highly reproducible manner. The membrane thickness is about 1.6 μm.

FIGS. 1C-1D show SEM images of the subsequent HMDS-silylated mesoporous silica on polyamide-imide (e.g., TORLON®) hollow fiber membranes. The continuous and uniform silica layers are not damaged by silylation. Also, there is no change in the membrane thickness or morphology after silylation.

### Gas Permeation Measurements

The gas permeation of the mesoporous silica membranes was measured using an in-house constructed hollow fiber permeation testing system. (See e.g., Al-Jualed, M.; Koros, W. J., J. MEMBR. SCI., 274 (2006) 227-243; Vu, D. Q., et al., IND ENG CHEM. RES., 41 (2002) 367-380). Gases were fed into the bore (“tube side”) of the fiber interior at one end of the module. The temperature of the system was maintained at 308° K during the measurement. The flux through the walls of the fiber was measured on the “shell side” connected to a bubble flow meter. Atmospheric pressure was maintained on the downstream side. The flux was converted to permeance and permeability, a preferred way of reporting pervaporation performance data. (See e.g., Baker, R. W., et al., J. MEMBR. SCI., 348 (2010) 346-352). Permeances are expressed in GPUs (Gas Permeation Units, 1 GPU=10⁻⁶ cm³(STP) cm⁻² s⁻¹ cmHg⁻¹) and permeabilities are given as Barrers (1 Barrer=10⁻¹⁰ cm³(STP) cm cm⁻² s⁻¹ cmHg⁻¹)

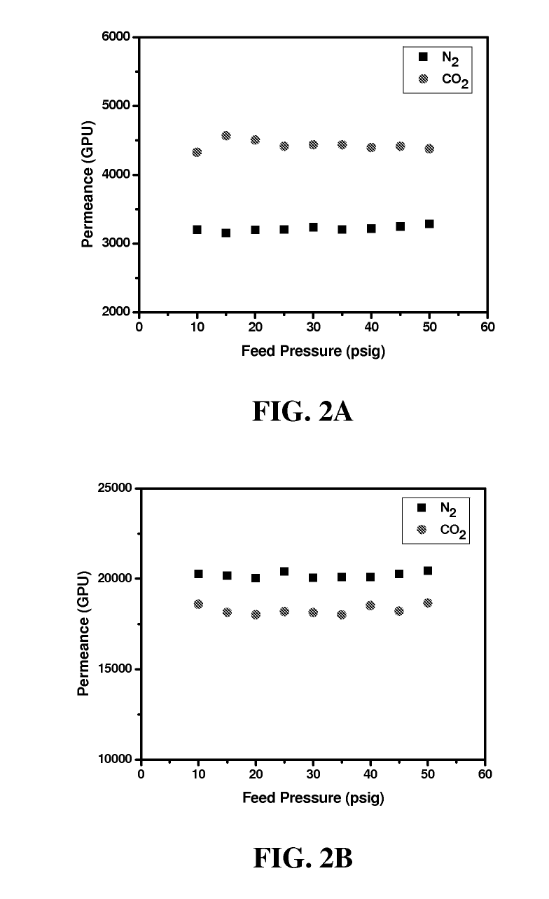

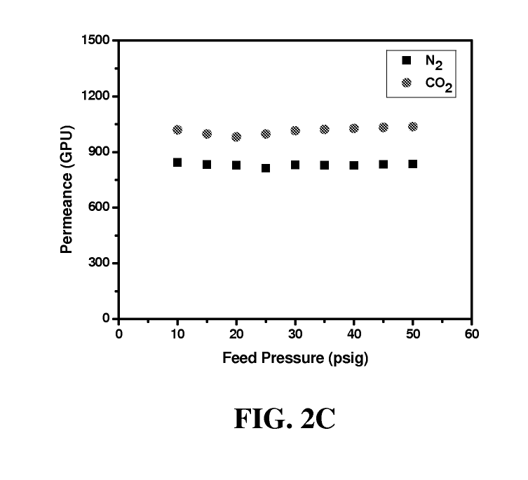

FIG. 2 shows single gas permeation data at 308° K for the extracted, evacuated, and subsequently silylated mesoporous silica on polyamide-imide (e.g., TORLON®) hollow fiber membranes at varying feed pressures. Compared to the non-evacuated membrane reported earlier (see Jang, K. S., et al., CHEM. MATER., 23 (2011) 3025-3028), the permeances of the evacuated membranes increase from 3,300 to 20,000 GPU for N₂ and from 4,400 to 18,000 GPU for CO₂. This indicates successful removal of adsorbed water and other species at 423° K. Moreover, the relative permeance of N₂ and CO₂ (1.11) is closer to the Knudsen ratio (i.e., Knudsen ratio: N₂/CO₂=1.25). Removal of residual species by evacuation activates the mesopores properly for subsequent pore modification.

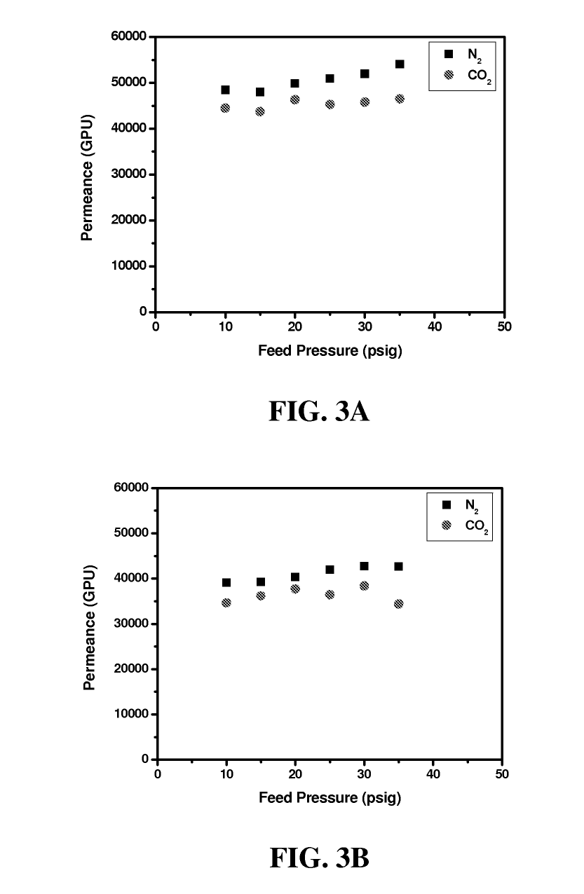

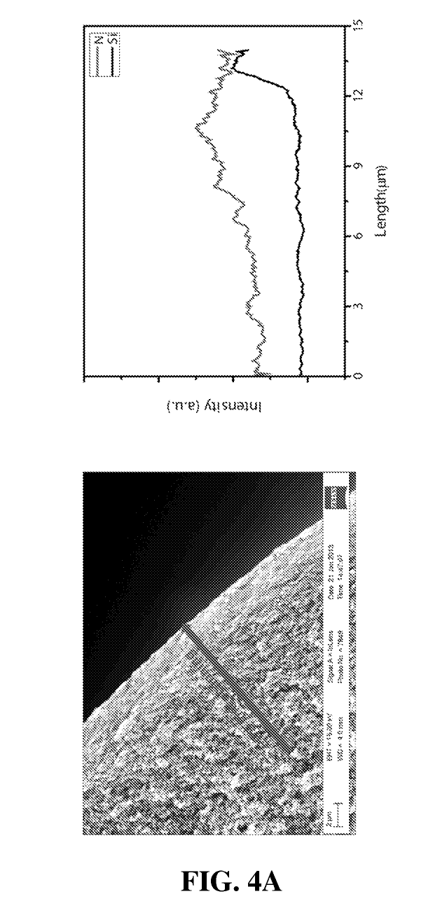

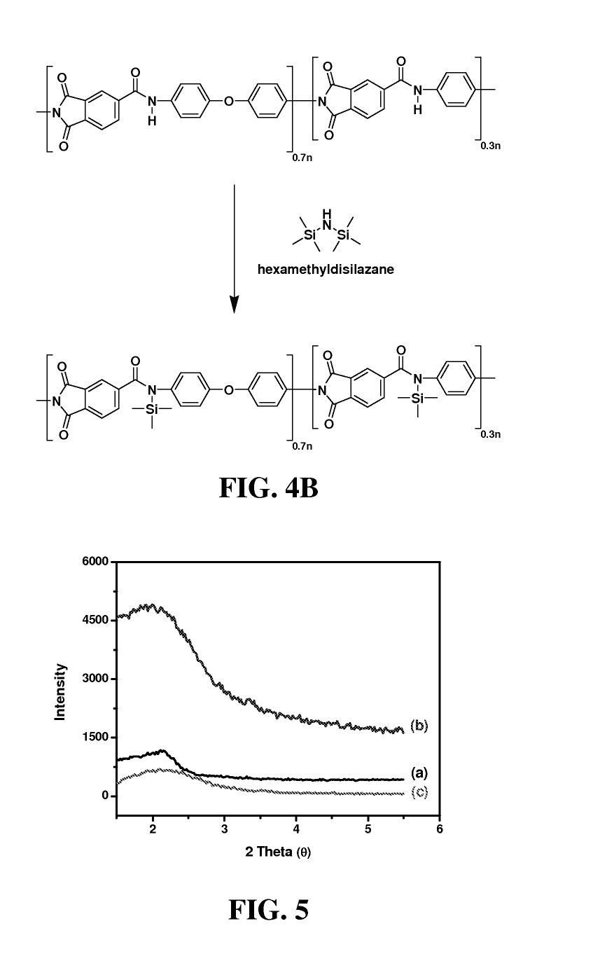

The gas permeances of the silylated mesoporous membranes were also measured. Permeances of N₂ and CO₂ decrease substantially after silylation, consistent with a reduction in porosity and decreased adsorption due to pore functionalization with trimethylsilyl groups. However, CO₂ shows less reduction, possibly due to its stronger adsorption on the silylated surface. As in the case of other mesoporous membranes (templated-extracted and evacuated membranes), the silylated mesoporous membranes have a constant permeance regardless of feed pressure, consistent with gas molecule transport being governed by a Knudsen-like mechanism. Surprisingly, a significant reduction of gas permeance may also be attributed to silylation of the polyamide-imide (e.g., TORLON®) support. As shown in FIGS. 3A-3B, the silica-free polyamide-imide (e.g., TORLON®) support also has a reduced permeance (10,000 GPU) after silylation. According to energy-dispersive X-ray spectroscopy analysis (see FIG. 4A), silicon species are detected on the outer surface of the polyamide-imide (e.g., TORLON®) hollow fiber, which otherwise should not contain any silicon. Presumably, the amide group in the polyamide-imide structure is silylated by HMDS (see Beaurecard, G. P., et al., J. APPL POLYMER SCI., 79 (2001) 2264-2271), as shown in FIG. 4B. The theoretical permeances under conditions for Knudsen transport are also estimated (N₂=47,000 GPU, CO₂=38,000 GPU), using the structural tortuosity factor of 3 for the mesoporous silica membrane. Then, the theoretical estimate can be further corrected for the presence of significant gas-solid interactions (adsorption of gases on the mesopore walls) rather than an ideal Knudsen mechanism. (See Kim, H. J., et al., J. MEMBR. SCI., 427 (2013) 293-302). This correction is based on parameters obtained directly from Bhatia, et al. (see Bhatia, S. K., LANGMUIR, 26 (2010) 8373-8385; Bhatia, S. K.; Nicholson, D., CHEM. ENG SCI., 66 (2011) 284-293) for silica mesopores of approximately 3 nm in pore diameter. The corrected theoretical permeances of mesoporous membrane are 23,500 GPU for N₂ and 19,000 GPU for CO₂, which are slightly higher than those of our evacuated membrane. The slight deviation is probably due to pore constrictions or dense material at the mesoporous silica on polyamide-imide (e.g., TORLON®) interface. Based on both gas permeation tests and comparison to theoretical values, it is clear that the mesoporous silica membranes on polyamide-imide (e.g., TORLON®) hollow fiber supports are successfully fabricated in a controlled manner.

### Pervaporation Measurements

Pervaporation measurements were carried out using an aqueous mixture of a specific organic (5 wt % organic) at 303° K and 323° K using an in-house constructed hollow fiber pervaporation testing system. (See Al-Jualed, M.; Koros, W. J., J. MEMBR. SCI., 274 (2006) 227-243; Vu, D. Q., et al., IND ENG CHEM. RES., 41 (2002) 367-380). The permeate was collected in a liquid nitrogen cooled trap. In contrast to the gas permeation tests, liquid mixtures were fed into the shell side and vaporized, whereby, they flowed through to the tube side. The total flux was obtained by measuring the mass of permeate collected in a given measurement time, and the permeate composition was characterized by gas chromatography (GC) and ¹H NMR in deuterated acetone.

### X-ray Diffraction Measurements

The pore structure of the mesoporous silica membrane was investigated in further detail by XRD and TEM imaging. The X-ray diffraction (XRD) patterns of the membranes were obtained by a PANalytical X'pert diffractometer using a Cu-K-alpha X-ray source, diffracted beam collimator, and a proportional detector. For XRD, the samples were aligned on the center of an aluminum mount and attached to the surface with double-sided tape. FIG. 5 illustrates the low angle XRD patterns of the mesoporous silica membranes at several stages of processing (template-extracted, evacuated, and silylated). Although an intense diffraction signal is difficult to obtain due to the curved surface of the sample and the thin membrane layer, the existence of mesoporous silica is clearly indicated. The increase (see FIG. 5: (b)) and decrease (see FIG. 5: (c)) in peak intensity due to evacuation and silylation of the template-extracted membrane (see FIG. 5: (a)) are due to the changes of electron density contrast between the mesopores and the silica walls, consistent with removal of residual species and modification of the pores with trimethylsilyl species, respectively.

### High-Resolution Transmission Electron Microscopy (TEM) Measurements

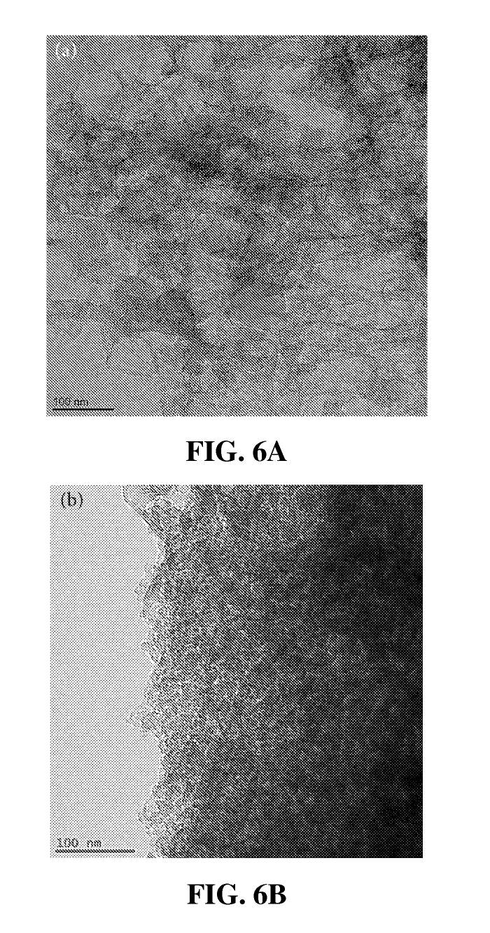

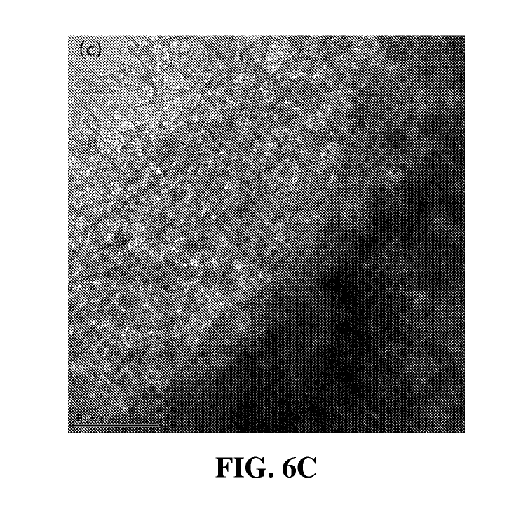

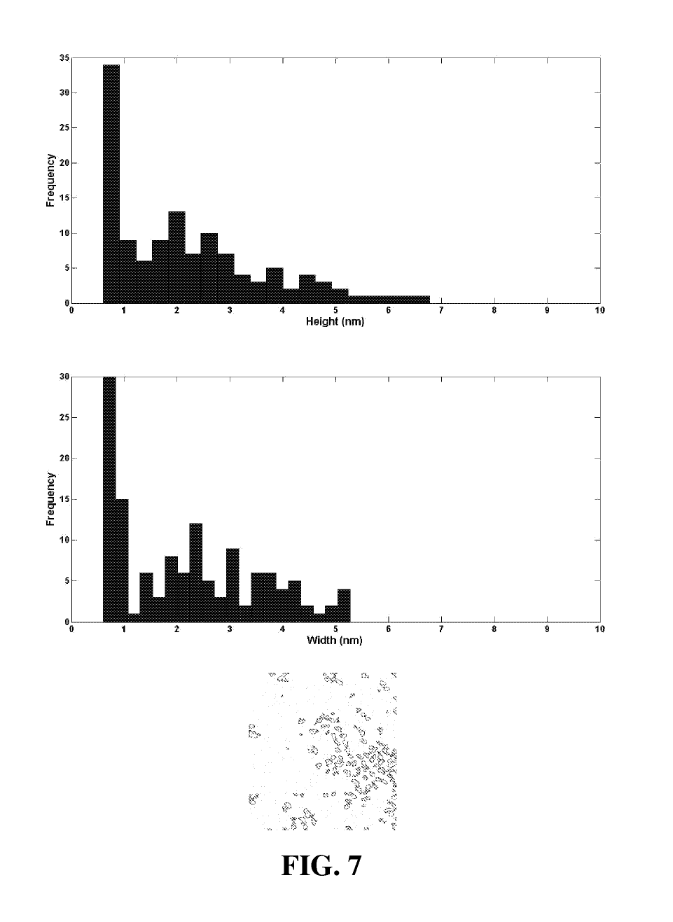

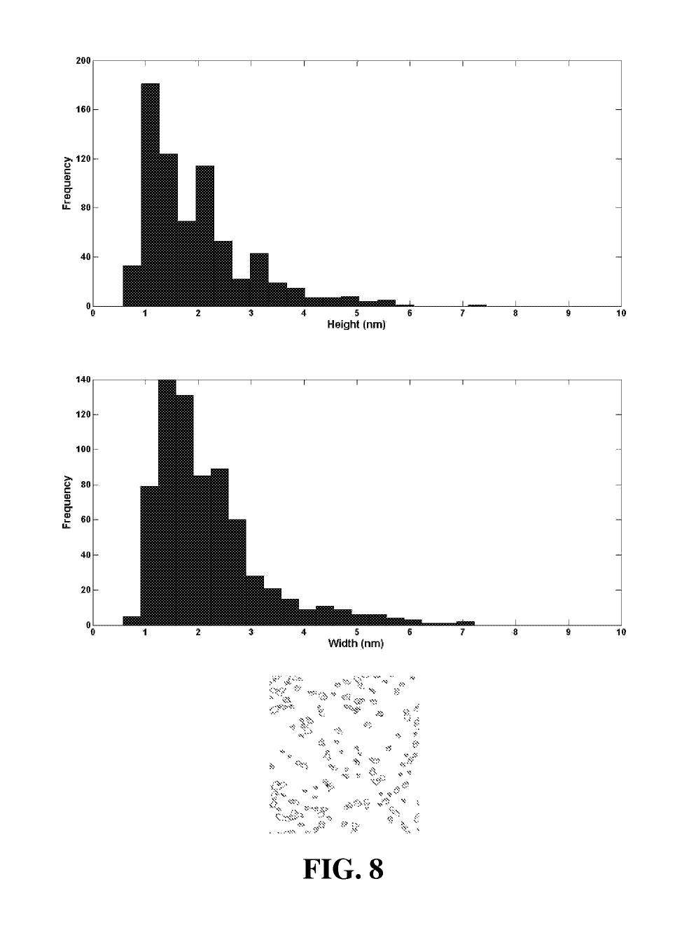

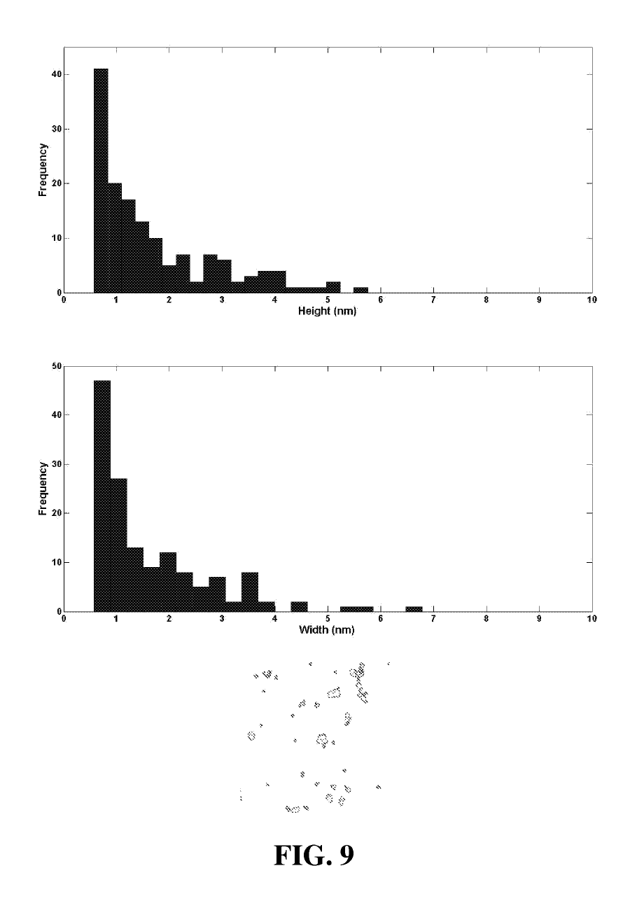

The silica layers of the same set of membranes were examined by high-resolution transmission electron microscopy (TEM). FIGS. 6A-6C illustrate TEM images of the (a) template-extracted, (b) evacuated, and (c) silylated mesoporous membrane layers after dissolution of the polyamide-imide (e.g., TORLON®) support fiber. The TEM was performed on a FEI Tecnai G² F30 TEM at 300 kV. For TEM, the samples were prepared after dissolving away the polyamide-imide (e.g., TORLON®) support fiber using a strong solvent, N,N-dimethylformamide. Based on the TEM images, pore sizes were estimated using NIH ImageJ software. In the selected area of worm-like mesopores, the pore size can be estimated by recognizing the pores as particles and using their width and height given by ImageJ. (See Belwalkar, A., et al., J. MEMBR. SCI., 319 (2008) 192-198; Collins, T. J., BIOTECHNIQUES, 43 (2007) 25-30). The remaining silica structure containing worm-like channels is observed for the membranes in each stage. Moreover, image analysis results for the height and width of the pores show that the pore size is consistent with the presence of a mesoporous material with a diameter of about 2 nm (see FIGS. 7-9). Interestingly, the pores of template-extracted (see FIG. 7) and silylated (see FIG. 9) membranes appear to be slightly smaller than those of the evacuated (see FIG. 8) mesoporous membrane, qualitatively indicating the reduction of the size of the pore channels due to the presence of surfactants and trimethylsilyl species. This analysis is consistent with the gas permeation measurements.

### Attenuated Total Reflectance (FT-ATR) Measurements

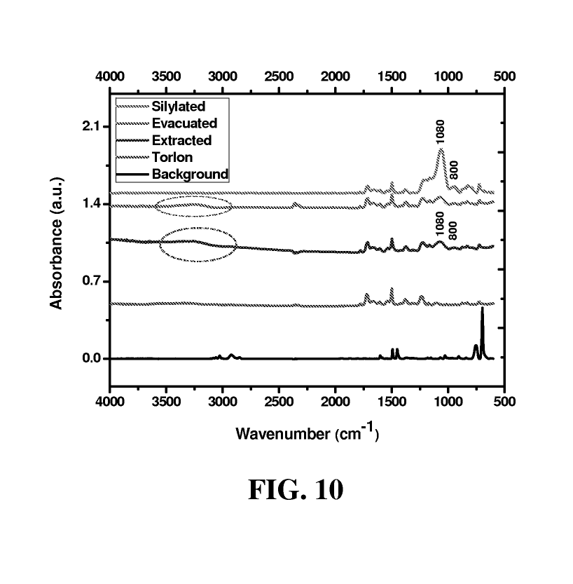

Attenuated total reflectance (FT-ATR) was used to investigate the modification of the silica layer. FIG. 10 shows the ATR-IR spectra of a mesoporous silica membrane at different stages of processing. FT-ATR spectra were obtained using a Bruker Vertex 80v Fourier Transform Infrared (FT-IR) spectrometer coupled to a Hyperion 2000 IR microscope at 20× magnification. The prepared samples were mounted on the poly(styrene) (PS) plates, and the PS plate itself was also measured to ensure that the ATR crystal was in proper contact with the samples. The absorption peak around 1080 cm⁻¹ is associated with the symmetric and asymmetric stretching vibrations of Si—O—Si linkages in mesoporous silica. After silylation of the mesoporous membrane, the intensity of this peak is significantly increased, which is likely due to the creation of additional Si—O—Si linkages by silylation. Also, the absorption peak around 800 cm⁻¹ is more intense as compared to the template-extracted membrane. On the other hand, a relatively broad absorption peak located at 3200-3600 cm⁻¹ is found in the template-extracted and evacuated membranes due to O—H stretching vibrations of the silanol groups and water molecules on the pore walls. These peaks completely disappear after silylation, suggesting that the surface silanols have been eliminated by condensation with the trimethylsilyl groups. (See Wu, S. F., et al., J. MEMBR. SCI., 390 (2012) 175181).

### Pervaporation Data for Five (5) Different Organic/Water Mixtures

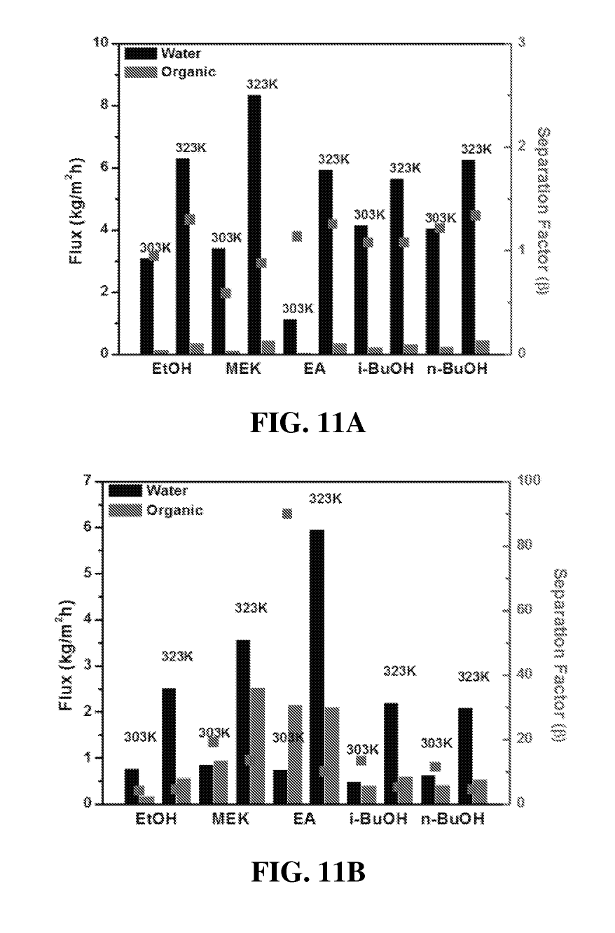

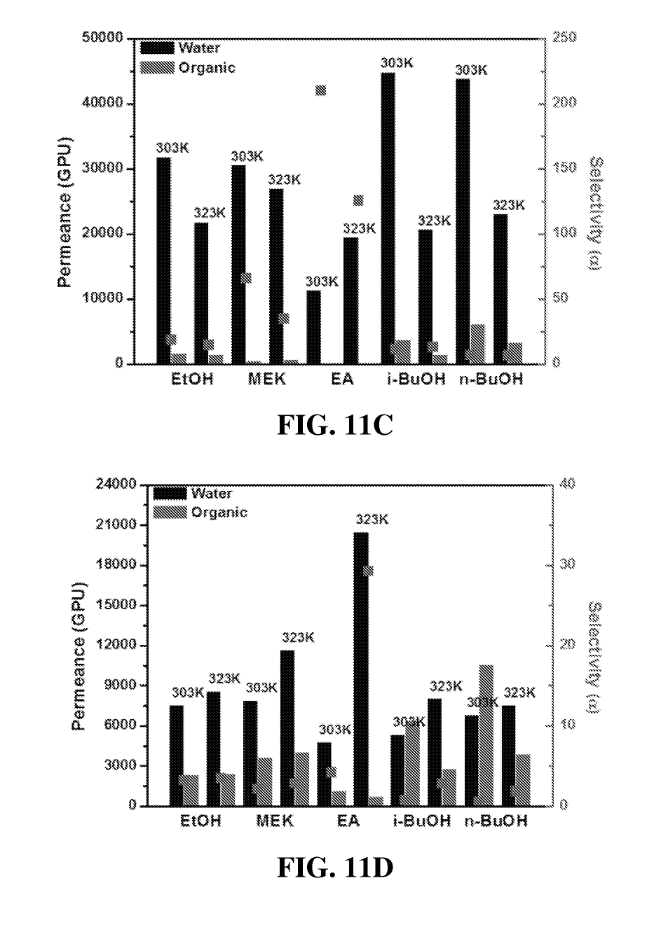

Pervaporation data for five different organic/water mixtures is summarized in FIGS. 11-13. To allow a comprehensive understanding of the permeation properties,⁵³ the data is expressed in terms of flux, organic/water separation factor, permeance, permeability, and water/organic selectivity for template-extracted membranes, evacuated membranes, and silylated membranes, respectively. The feed mixtures used were (5/95 w/w) EtOH/water, MEK/water, EA/water, i-BuOH/water, and n-BuOH/water. The pervaporation experiments were performed at 303° K and 323° K.

FIGS. 11A-11B illustrate the fluxes and organic/water separation factors from the mixture pervaporation experiments. Beyond the model solutions composed of MEK and water or EA and water, the hydrophobic mesoporous membranes were also investigated for BuOH/water separations, due to the emerging importance of BuOH as a liquid fuel. (See Schoutens, G. H.; Groot, W. J., PROCESS BIOCHEM., 20 (1985) 117-121). Both organic and water fluxes increase with temperature, but it is noteworthy that the water flux increases more than the organic flux. The separation factors of all the organic/water mixtures through the evacuated membranes range from about 0.5 to about 1.5, indicating that the membranes are not selective. They permeate almost the same amount of water and organic as is present in the feed mixture. However, the separation factor increases substantially after silylation, as this treatment renders the pore surface hydrophobic via modification by trimethylsilyl groups. The total fluxes somewhat increase or are maintained constant after silylation, and this is caused by a large increase in the fluxes of the organic species after silylation. The separation factors (organics-over-water) of the HMDS-treated mesoporous membrane at 303° K vary with the organic components in the order: EA (90)>MEK (19)>i-BuOH (13)>n-BuOH (11)>EtOH (4). On the other hand, higher water fluxes lead to decreased separation factors at the higher temperature of 323° K.

FIGS. 11C-11D illustrate the permeances and water-over-organic selectivities (ratio of water and organic component permeances) for the two membranes, calculated from the membrane transport equation for any component i:

Jᵢ=(P_{m,i})(γᵢxᵢpᵢ^{sat}−yᵢpₚ)Jᵢ=(P_{m,i})(γᵢxᵢpᵢ^{sat}−yᵢpₚ)

where Jᵢ is the molar flux of component i, P_{m,i} the permeance, γᵢ the activity coefficient, xᵢ the feed mole fraction, pᵢ^{sat} the saturated vapor pressure, yᵢ the permeate mole fraction, and pₚ the permeate pressure.

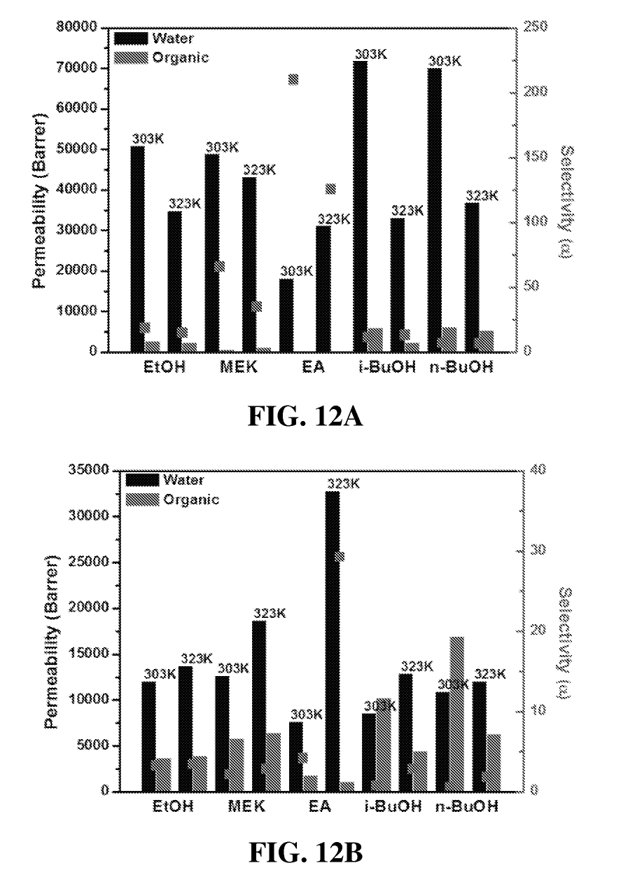

Interestingly, the permeances of the organic species do not change much with increasing temperature, whereas the permeance of water increases significantly at 323° K. This result indicates that the permeance of the organic species is more highly dependent on adsorption of the components into the mesopores rather than diffusivity in the mesopores. Even though the silylated mesoporous membrane has high organic fluxes and high organic separation factors (see FIG. 11B), it still has intrinsic water/organic selectivity in the range of about 0.5 to about 4 at 303° K. This is because the original non-silylated mesoporous membrane is highly hydrophilic and water selective. In other words, the trimethylsilyl groups are able to drastically decrease the flux of water through the membrane, but it still remains on the same order of magnitude as the organic fluxes. FIGS. 12A-12B illustrate the same information as FIGS. 11C-11D except that the permeability is displayed instead of permeance. The silylated membranes display high permeabilities (on the order of 1,000 Barrer) for the organic species.

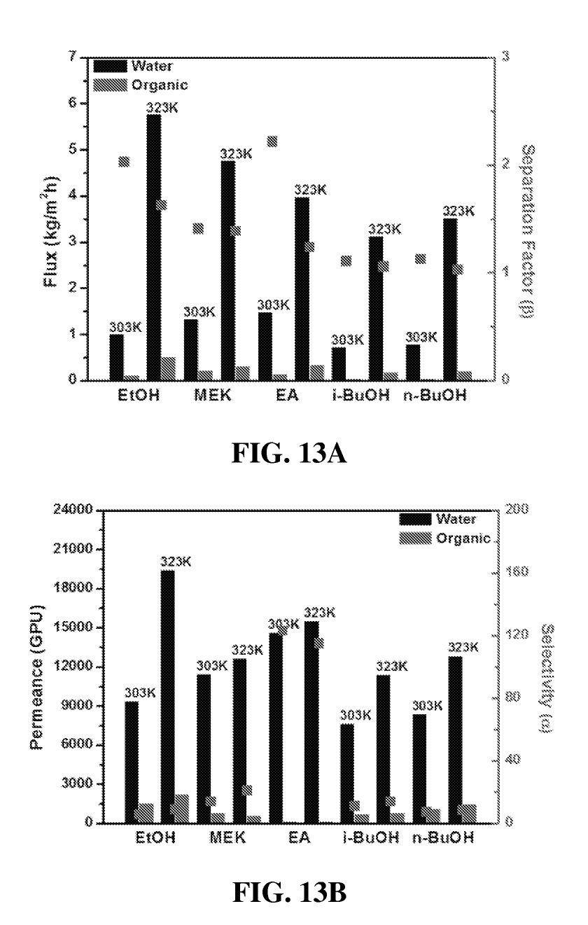

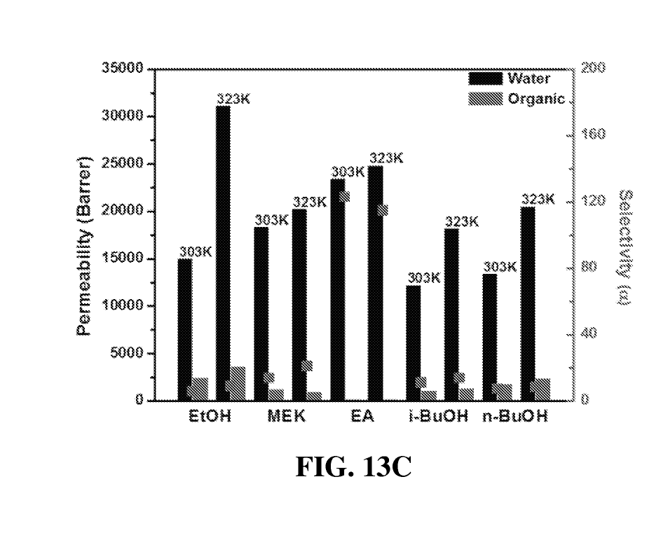

FIGS. 13A-13B represent the pervaporation data for the template-extracted mesoporous membrane. Similar to the evacuated membrane, the extracted membrane shows low organic separation factors (about 1 to about 2.5) and high water selectivities (about 6 to about 130). However, it has a significantly lower flux and permeance, because the residual surfactants and solvents partially block permeation.

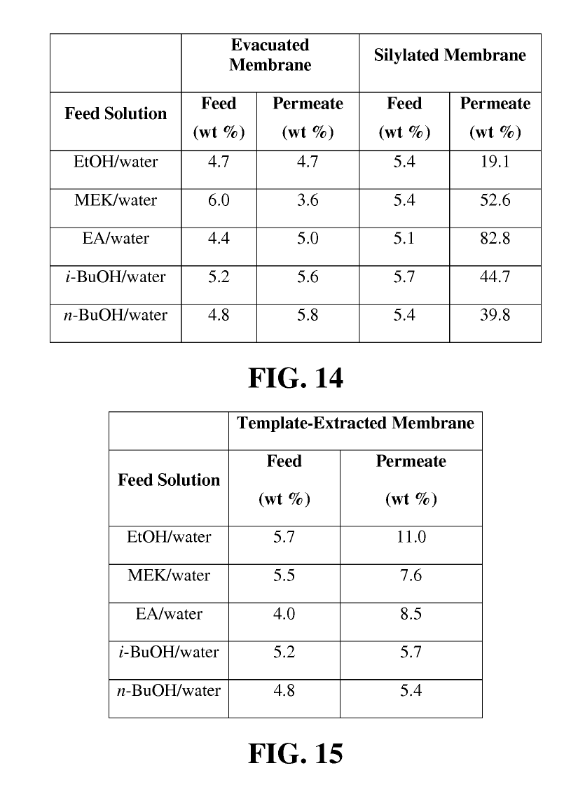

As a result of the pervaporation properties discussed above, the inventors found that the silylated mesoporous silica on polyamide-imide (e.g., TORLON®) hollow fiber membranes according to an embodiment of the present invention are able to upgrade 5 wt % organic/water feed mixtures to 19% EtOH, 53% MEK, 83% EA, 45% i-BuOH, and 40% n-BuOH permeate streams in a single pass at 303° K (see FIG. 14 (Table 1)). As shown in FIG. 14 (Table 1), this separation performance is considerably better than that of the template-evacuated membranes and the template-extracted mesoporous silica membranes (see FIG. 12 (Table 2)).

### Other Organic/Water Mixtures

Similarly, these template-extracted membranes, evacuated membranes, and silylated membranes may also be used to upgrade other organic/mixtures. In various embodiments of the present invention, other alcohol/water feed mixtures may be used to upgrade the organic component to a significantly higher concentration. For example, the organic/water feed mixtures may be (about 2/98 w/w to about 20/80 w/w) EtOH/water, MEK/water, EA/water, i-BuOH/water, and n-BuOH/water. The alcohol/water pervaporation separations may be performed at about 300 to 325° K, as discussed above.

In other embodiments, other organic/water feed mixtures may be used to upgrade the organic component as summarized below in Table 3. The organic/water feed mixtures may contain one or more compounds. Each organic compound in water may have a concentration range of about 2/98 w/w to 20/80 w/w for acids/water, alcohols/water, aldehydes/water, ethers/water and ketones/water, and a concentration range of about 20/80 w/w to 40/60 w/w for sorbitol/water and sugars/water.

TABLE 3

| | | Preferred | |
|---|---|---|---|
| | Concentration | Concentra- | Temperature |
| Organic/Water | Range | tion Range | Range |
| Mixture | (w/w) | (w/w) | ° K. |
| Oxygenates/Water | ~2/98 to ~20/80 | ~10/90 | ~300 to ~325 |
| Alcohols/Water | ~2/98 to ~20/80 | ~10/90 | ~300 to ~325 |
| Aldehydes/Water | ~2/98 to ~20/80 | ~10/90 | ~300 to ~325 |
| Ethers/Water | ~2/98 to ~20/80 | ~10/90 | ~300 to ~325 |
| Ketones/Water | ~2/98 to ~20/80 | ~10/90 | ~300 to ~325 |
| Sorbitols/Water | ~20/80 to ~40/60 | ~30/70 | ~300 to ~325 |
| Sugars/Water | ~20/80 to ~40/60 | ~30/70 | ~300 to ~325 |

In an embodiment, the oxygenates may be selected from the group consisting of acids, alcohols, aldehydes, cyclic ethers, cyclic ketones, ethers, and ketones. In an embodiment, the oxygenates may be selected from C1 to C6 oxygenates.

In an embodiment, the acids may be selected from the group consisting of C2 to C6 acids. In an embodiment, the acids may be selected from the group consisting of acetic acid (HAc) and propanoic acid (HPr).

In an embodiment, the alcohols may be selected from the group consisting of C1 to C6 alcohols. In an embodiment, the alcohols may be selected from the group consisting of MeOH, EtOH, PrOH, i-BuOH and n-BuOH.

In an embodiment, the aldehydes may be selected from the group consisting of C2 to C6 aldehydes. In an embodiment, the aldehydes may be selected from the group consisting of acetaldehyde (AA) and propanal.

In an embodiment, the ethers may be selected from the group consisting of C2 to C6 ethers. In an embodiment, the cyclic ethers may be selected from the group consisting of C4 to C6 cyclic ethers. In an embodiment, the cyclic ethers may be selected from a group consisting of tetrahydrofuran (THF) and dioxane (Di). In an embodiment, the ether is EA.

In an embodiment, the ketones may be selected from the group consisting of C3 to C6 ketones. In an embodiment, the ketones may be selected from the group consisting of acetone, butanone and hexanone. In an embodiment, the ketone is MEK.

In an embodiment, the cyclic ketones may be selected from the group consisting of C5 to C6 cyclic ketones. In an embodiment, the cyclic ketones may be selected from the group consisting of cyclopentanone and cyclohexanone.

In an embodiment, the sugars may be selected from the group consisting of monosaccarides, disaccharides, fructose (Fru), sucrose (Suc) and glucose (Glu).

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. §1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

### DEFINITIONS

As used herein, the terms “a,” “an,” “the,” and “said” means one or more.

As used herein, the term “about” means the stated value plus or minus a margin of error or plus or minus 10% if no method of measurement is indicated.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise,” provided above.

As used herein, the terms “having,” “has,” and “have” have the same open-ended meaning as “comprising,” “comprises,” and “comprise,” provided above.

As used herein, the terms “including,” “includes,” and “include” have the same open-ended meaning as “comprising,” “comprises,” and “comprise,” provided above.

As used herein, the phrase “consisting essentially of” occupies a middle ground, allowing the addition of non-material elements that do not substantially change the nature of the invention, such as various buffers, differing salts, extra wash or precipitation steps, pH modifiers, and the like.

As used herein, the phrase “consisting of” is a closed transition term used to transition from a subject recited before the term to one or more material elements recited after the term, where the material element or elements listed after the transition term are the only material elements that make up the subject.

As used herein, the phrase “free of defects” means that the mesoporous coating is at least 95% free of defects, and preferably at least 97, 98, 99 or 100% free of defects, and that any existing defects are less than 10 nm in diameter, preferably not more than the pore width, such that the coating is essentially continuous and does not allow the gas or liquid to be treated to escape through, e.g., a large crack in the coating.

As used herein, the term “mesoporous” means a three-dimensional (3D) structure of interconnected pores ranging in diameter from 0.1-10 nm. Preferably, the pore sizes range between 1-5 nm or 2-4 nm in diameter, but the sizes can be varied depending on which gases or liquids are to be separated.

As used herein, the term “polymer” includes polymer made from one or more monomeric units, and, thus, includes polymers, copolymers, block polymers, terpolymers and the like unless indicated otherwise.

As used herein, the term “simultaneously” means occurring at the same time or about the same time, including concurrently.

### Abbreviations

The following abbreviations are used herein:

| | |
|---|---|
| AA | Acetaldehyde |
| Acetone | Acetone |
| HAc | Acetic Acid |
| Butanone | Butanone |
| CTAB | Cetyltrimethylammonium bromide |
| Cyclopentanone | Cyclopentanone |
| Cyclohexanone | Cyclohexanone |
| Disaccharides | Disaccharides |
| Di | Dioxane |
| EtOH | Ethanol |
| EA | Ethyl acetate |
| EDS | Energy-dispersive X-ray spectroscopy |
| FT-ATR | Attenuated total reflectance (ATR) spectra |
| | obtained from fourier transform infrared |
| | (FT-IR) spectrometer |
| FT-IR | Fourier transform infrared spectrometer |
| Fru | Fructose |
| Glu | Glucose |
| HFP | Hexafluoropropene |
| HMDS | Hexamethyldisilazane |
| Hexanone | Hexanone |
| HC1 | Hydrochloric acid |
| i-BuOH | isobutanol |
| i-PrOH | isopropanol |
| MeOH | Methanol |
| MEK | Methylethyl ketone |
| Monosaccharides | Monosaccharides |
| n-BuOH | n-butanol |
| PAI | Polyamide-imide |
| PDMS | Polydimethylsiloxane |
| PEBA | Poly (ether) block amide |
| POMS | Polyoctylmethyl siloxane |
| PS | Polystyrene |
| PTFE | Polytetrafluoroethylene |
| PTMSP | Poly(1-trimethylsilyl-1-propyne) |
| PVDF | Polyvinylidene |
| PVP | Polyvinylpyrrolidone |
| Propanal | Propanal |
| HPr | Propanoic acid |
| PrOH | Propanol |
| sec-BuOH | sec-butanol |
| SEM | Scanning electron microscope |
| Sorbitol | Sorbitol |
| Suc | Sucrose |
| TEOS | Tetraethylorthosilicate |
| tert-BuOH | tert-butanol |
| THF | Tetrahydrofuran |
| TOA | Trioctylamine |
| XRD | X-ray diffraction |

### INCORPORATION BY REFERENCE

All patents and patent applications, articles, reports, and other documents cited herein are fully incorporated by reference to the extent they are not inconsistent with this invention, as follows:
1) Aksay, I. A., et al., SCIENCE, 273 (1996) 892-898;
2) Yang, H., et al., J. MATER. CHEM., 7 (1997) 1285-1290;
3) Miyata, H., et al., NAT. MATER., 3 (2004) 651-656;
4) Jang, K. S., et al., CHEM. MATER., 23 (2011) 3025-3028;
5) Kim, H. J., et al., J. MEMBR. SCI., 427 (2013) 293-302;
6) Brown, A. J., et al., ANGEW CHEM. INT EDIT, 51 (2012) 10615-10618;
7) Belwalkar, A., et al., J. MEMBR. SCI., 319 (2008) 192-198;
8) Collins, T. J., BIOTECHNIQUES, 43 (2007) 25-30;
9) Al-Jualed, M.; Koros, W. J., J. MEMBR. SCI., 274 (2006) 227-243;
10) Vu, D. Q., et al., IND ENG CHEM. RES., 41 (2002) 367-380;
11) Baker, R. W., et al., J. MEMBR. SCI., 348 (2010) 346-352;
12) Beaurecard, G. P, et al., J. APPL POLYMER SCI., 79 (2001) 2264-2271;
13) Bhatia, S. K., LANGMUIR, 26 (2010) 8373-8385;
14) Bhatia, S. K.; Nicholson, D., CHEM. ENG SCI., 66 (2011) 284-293;
15) Wu, S. F., et al., J. MEMBR. SCI., 390 (2012) 175181;
16) Baker, R. W., et al., J. MEMBR. SCI., 348 (2010) 346-352; and
17) Schoutens, G. H.; Groot, W. J., PROCESS BIOCHEM., 20 (1985) 117-121.

What is claimed is:

1) a liquid separation device comprising:
a) a porous support structure further comprising polymeric hollow fibers;
b) an inorganic mesoporous silica membrane disposed on the porous support structure,
c) wherein the inorganic mesoporous silica membrane is free of defects; and
d) wherein the inorganic mesoporous silica membrane has a network of interconnected three-dimensional pores that interconnect with the porous support structure; and
e) wherein the inorganic mesoporous silica membrane is a silylated mesoporous membrane.

2) The liquid separation device of claim 1, wherein the pores range between about 1 nm to about 5 nm in diameter.

3) The liquid separation device of claim 3, wherein the pores range between about 2 nm to about 4 nm in diameter.

4) The liquid separation device of claim 1, wherein the inorganic material comprises a composite mesoporous material, the composite mesoporous material comprising a mesoporous silica and cetyltrimethylammonium bromide.

5) The liquid separation device of claim 1, wherein the silylation agent is selected from the group consisting of hexamethyldisilazane and heptamethyldisilazane.

6) The liquid separation device of claim 5, wherein the silylation agent is hexamethyldisilazane.

7) A method for fabricating the liquid separation device of claim 1, the method comprising:
a) preparing a coating solution, wherein the coating solution comprises a mixture of silica source, a quaternary amine surfactant and acidic water;
b) providing polymeric hollow fibers;
c) immersing at least a portion of the polymeric hollow fibers in the coating solution, thereby forming a wet mesoporous silica membrane on the polymeric hollow fibers;
d) rinsing and drying the wet mesoporous silica membrane on the polymeric hollow fibers, thereby forming a dried mesoporous silica membrane on the polymeric hollow fiber;
e) aging the dried mesoporous silica membrane by exposure to a source of silica;
f) extracting the surfactant from the mesoporous coating by treatment with a solvent;
g) evacuating the solvent and the surfactant from the mesoporous coating by treatment under vacuum, thereby forming an evacuated mesoporous silica membrane;
h) reacting the evacuated mesoporous silica membrane by treatment with a silylation agent, thereby forming a silylated mesoporous membrane; and
i) rinsing and drying the silylated mesoporous membrane on the polymeric hollow fibers.

8) The method of claim 7, wherein the quaternary amine surfactant comprises cetyltrimethylammonium bromide (CTAB), and wherein the coating solution comprises 1.0 R:a CTAB:b H2O, wherein R is a source of silica, a is between about 0.1 and about 1, and b is between about 20 and about 200.

9) The method of claim 7, wherein the preparing step comprises adding acid species to the solution such that the pH of the prepared solution is between about 0 and about 4.

10) The method of claim 7, wherein the immersing step comprises immersing the polymeric hollow fibers in the coating solution for a period between about 10 minutes and about 24 hours.

11) The method of claim 7, wherein the aging step comprises aging the dried mesoporous silica membrane by exposure to saturated alkoxysilane vapor.

12) The method of claim 7, wherein the reacting step comprises reacting the evacuated mesoporous silica membrane by exposure to the silylation agent in a closed vessel at about 373° K for about 24 hours.

13) The method of claim 7, wherein the silylation agent is selected from the group consisting of hexamethyldisilazane and heptamethyldisilazane.

14) A method of using the liquid separation device of claim 1, the method comprising:
a) maintaining the liquid separation device at a temperature between about 300 and about 325° K;
b) maintaining about atmospheric pressure on a shell side of the liquid separation device;
c) feeding a liquid organic/water mixture into a tube side of the liquid separation device, wherein the organic/water mixture may be selected from the group consisting of oxygenates/water, sorbitol/water and sugar/water;
d) collecting upgraded organic/water mixture on the shell side of the liquid separation device.

15) The method of claim 14, wherein the organic/water mixture has a concentration range of about 2/98 w/w to about 20/80 w/w and wherein the organic/water mixture is selected from the group consisting of C2 to C6 acids/water, C1 to C6 alcohols/water, C2 to C6 aldehydes/water, C2 to C6 ethers/water, and C3 to C6 ketones/water.

16) The method of claim 15, wherein the concentration range is about 2/98 w/w to about 10/90 w/w.

17) The method of claim 14, wherein the organic/water mixture has a concentration range of about 20/80 w/w to about 40/60 w/w and wherein the organic/water mixture is selected from the group consisting of sorbitol/water and sugar/water.

18) The method of claim 14, wherein the organic/water mixture is selected from the group consisting of propionic acid/water, acetic acid/water, methanol/water, ethanol/water, propanol/water, isobutanol/water, n-butanol/water, actaldehyde/water, propanal/water, tetrahydrofuran/water, dioxane/water, ethyl acetate/water, acetone/water, butanone/water, hexanone/water, cyclopentanone/water and cyclohexanone/water.

19) The method of claim 18, wherein the organic/water mixture is selected from the group consisting of methanol/water, ethanol/water, propanol/water, isobutanol/water, n-butanol/water, methyl ethyl ketone/water and ethyl acetate/water.

20) The method of claim 19, wherein the organic/water concentration range is about 20/80 w/w to about 30/70 w/w.
